(19) United States
(12) Patent Application Publication
(10) Pub. No.: US 2003/0207601 A1
(43) Pub. Date: Nov. 6, 2003

(54) Socket

(75) Inventor: Shosuke Adachi, Nagoya (JP)

Correspondence Address: BACON & THOMAS, PLLC, 625 SLATERS LANE, FOURTH FLOOR, ALEXANDRIA, VA, 22314

(73) Assignee: HATAYA MFG. CO., LTD., Nagoya (JP)

(21) Appl. No.: 10/294,559

(22) Filed: Nov. 15, 2002

(30) Foreign Application Priority Data
May 1, 2002 (JP) 2002-129852

(51) Int. Cl. H01R 13/44

(52) U.S. Cl. 439/135

(57) ABSTRACT

A socket body 3 comprises a socket-forming section 4 having a mounting groove 6 around the outer periphery thereof. A cap 7 is integrally formed with a ring-shaped mounting portion 13 through a tether 12. The cap 7 may be mounted on the socket body 3 by engaging the mounting portion 13 in the mounting groove 6. Mounting the cap 7 on the socket body 3 requires no fastening members such as screws, thereby reducing the number of parts thereof and the number of assembly steps in comparison with those which require fastening members.

### FIELD OF THE INVENTION

The invention relates to a socket provided with caps for closing the prong openings in the socket body thereof.

### PRIOR ART

Heretofore it has been known to provide caps for a socket connected to one end of an electric extension cord for closing the prong openings on the socket body of the socket in order to prevent foreign matters, such as moisture and dirt, etc., from entering the prong openings. Heretofore such caps are mounted on the socket body by using fastening components such as screws.

Heretofore, mounting such caps requires the use of fastening components such as screws, and this would increase the number of components as well as the number of assembly steps, causing the increase of the cost of the socket.

### SUMMARY OF THE INVENTION

In view of the above, it is an object of the invention to provide a socket having caps which can reduce the number of components and the number of assembly steps. Further, the cost of the socket can also be reduced.

The object is obtained by the characteristics of the invention defined in the appended claim 1 which comprises: a socket body having a plurality of prong openings, at least one mounting groove provided on the socket body, at least one cap for closing the prong openings, the at least one cap each being integrally formed with a flexible, ring-shaped mounting portion which can be fitted in the at least one mounting groove.

With the above-mentioned structure, by positioning the ring-shaped mounting portion integrally formed with the cap in the mounting groove of the socket body, the cap can be mounted on the socket body. Thus, when mounting the cap on the socket body, fixing components such as screws are not needed. Further, the number of assembly steps can also be reduced, and in turn, the cost of the socket, as compared with the case of using fixing components.

### BRIEF DESCRIPTION OF THE DRAWINGS

FIG. 1 is a perspective view showing a first embodiment of the socket of the present invention.

FIG. 2 is a perspective view showing a second embodiment of the socket of the present invention.

### DETAILED DESCRIPTION OF THE PREFERRED EMBODIMENT

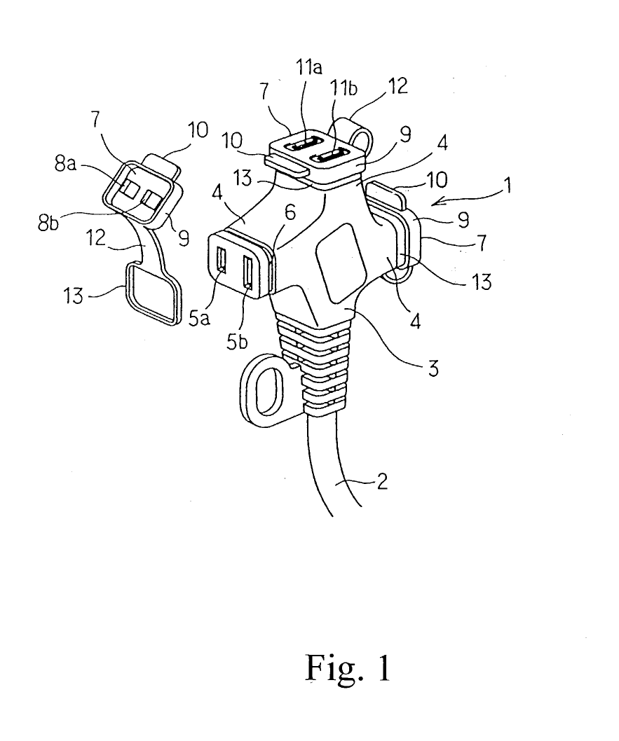

A first embodiment of the present invention will be described below in conjunction with FIG. 1. A socket 1 in accordance with the invention is connected to an end of an electric power cord 2. Socket 1 has a socket body 3 made of synthetic resin and integrally formed with three socket-forming sections 4 projecting therefrom. Each socket-forming section 4 has a substantially rectangular cross-section and a pair of prong openings 5a and 5b (only one pair shown in FIG. 1) formed in its end face to receive the prongs of a plug (not shown). Further, an annular mounting groove 6 is formed around the periphery of each socket-forming section 4.

A cap 7 can be mounted on each socket-forming section 4 for closing the prong openings 5a and 5b. Cap 7 may be made of synthetic resin, for example, vinyl chloride. Cap 7 has a substantially rectangular cross section corresponding to the end face of the socket-forming section 4 and a pair of integrally formed prongs 8a and 8b extending from its inner surface, the prongs 8a and 8b being configured to engage the prong openings 5a and 5b. Cap 7 also has an integrally formed annular lip 9 extending along its periphery and a finger tab 10 on one side of the periphery. On the outer surface of the cap 7 opposite the inner surface having prongs 8a and 8b, there is formed with recesses 11a and 11b of the shape corresponding to that of the prong openings 5a and 5b. Moreover, on the side opposite the finger tab 10, a mounting portion 13 in the shape of a rectangular ring is integrally formed with the cap 7 by a tether 12. In this case, tether 12, mounting portion 13 and cap 7 are all made of vinyl chloride and have elasticity and flexibility.

Each cap 7 can be secured to each socket-forming section 4 by fitting the mounting portion 13 in the mounting groove 6 of the socket-forming section 4. The elasticity and flexibility of the mounting portion 13 permits the easy positioning of the mounting portion 13 in the mounting groove 6. The cap 7 may be removably fixed on the socket-forming portion 4 not only by the prongs 8a and 8b which engage the prong openings 5a and 5b, but also the annular lip 9 which engages the outer periphery of the socket-forming section 4. When the cap 7 is fixed over the socket-forming section 4, the cap not only covers the end face of the socket-forming section 4, but also closes the prong openings 5a and 5b, thereby preventing foreign matters from entering the prong openings 5a and 5b. If a user wants to remove the cap 7 from the end face of the socket-forming portion 4, the user may hold the finger tab 10 to peel and pull off the cap 7 from the end face of the socket-forming section 4.

According to the above-mentioned embodiment, the cap 7 is mounted on the socket body 3 through the ring-shaped mounting portion 13 which is formed integrally with the cap and positioned in the mounting groove 6 of the socket-forming section 4 of the socket body 3. Therefore, mounting the caps 7 on the socket body 3 requires no fastening means such as screws. This can reduce the number of parts thereof and the number of assembly steps in comparison with those which require fastening means. And the cost of the socket is further reduced. Further, with the structure allowing the positioning the mounting portion 13 in the mounting groove 6 of the socket-forming section 4, the invention has the advantage of better appearance as the mounting portion 13 hardly projects from the socket body 3.

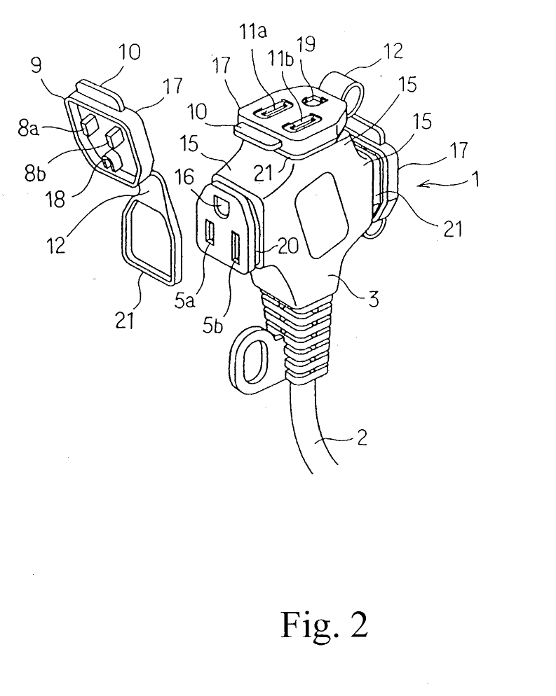

FIG. 2 illustrates a second embodiment of the socket of the invention. The difference between the second embodiment and the previously described embodiment will be explained below. Like parts are, therefore, designated by like reference numerals.

The socket 1 has a socket body 3 integrally formed with socket-forming sections 15. In addition to prong openings 5a and 5b, a ground prong opening 16 is formed in the end face of each socket-forming section 15 of the socket body 3, and the end face of each socket-forming section 15 is changed in its shape correspondingly. Each of caps 17 takes a shape corresponding to the shape of the end face of the socket-forming section 15. In addition to prongs 8a and 8b extending from the inner surface of the cap 17, a prong 18 is provided on the inner surface for plugging in the prong opening 16. On the external surface of the cap 17, a recess 19 corresponding to the prong opening 16 is also formed, in addition to the recesses 11a and 11b corresponding to the prong openings 5a and 5b.

A mounting groove 20 is formed around the periphery of each socket-forming section 15. The cap 17 has a mounting portion 21 of a ring shape corresponding to that of the mounting groove 20. The cap 17 can be mounted on the socket body 3 by fitting the ring-shaped mounting portion 21 in the mounting groove 20.

The second embodiment can achieve the same effect as the first embodiment does as well.

The present invention is not limited to the above-mentioned embodiments, and may be modified or expanded as below.

It will be understood that although the socket 1 illustrated has three pairs of prong openings 5a and 5b, it may have only one pair. Further, the present invention may also be applied to a wall socket and the like.

It will be understood that with the structure of the invention, the cap can be mounted on the socket body by positioning the integrally formed ring-shaped mounting portion in the mounting groove of the socket body. Thus, when mounting the cap on the socket body, fixing components such as screws are not required. This would reduce the number of parts. Further, the number of assembly steps can also be reduced as compared with the case of using fixing components. And the cost of the socket is also reduced.

What is claimed is:

1. A socket comprising:
a socket body having a plurality of prong openings;
at least one mounting groove provided on the socket body;
at least one cap for closing the prong openings, the at least one cap each being integrally formed with a flexible, ring-shaped mounting portion which can be fitted in the at least one mounting groove.
